(19) United States
(12) Patent Application Publication
(10) Pub. No.: US 2023/0081861 A1
(43) Pub. Date: Mar. 16, 2023

(54) MAPPING SYSTEM DISPLAYING MAPS WITH VIDEO DATA LAYERS AND MULTIVIEW VIDEO DISPLAYS

(71) Applicant: BINDU RAMA RAO, Laguna Niguel, CA (US)

(72) Inventor: BINDU RAMA RAO, Laguna Niguel, CA (US)

(21) Appl. No.: 17/472,517

(22) Filed: Sep. 10, 2021

(51) Int. Cl. G01C 21/00; G06F 3/0481

(52) U.S. Cl. CPC G01C 21/3863; G06F 3/0481; G01C 21/3896

(57) ABSTRACT

A mapping system for multiview video displays presents an interactive map comprising a plurality of regularly distributed grid points indicating availability of multiview display data at those grid points. When selected, each of the grid points present a plurality of videos, images, and other data collected that are available for display.

### CROSS REFERENCES TO RELATED APPLICATIONS

### Background

### 1. Technical Field

The present invention relates generally to a map display using a mobile device and particularly to a solution wherein a user can view multiple videos and other data for each grid point on the map displayed.

### 2. Related Art

A typical map shows streets and roads and some terrain information. Hikers use topological maps that show how elevation varies in an area. Satellite images show how the regions of earth look from the sky. One can zoom into some specific location using some map viewing tools, that are able to provide a little more details than just satellite images.

There is a need to for greater detail of topological features, greater ways to understand how a building or geographical feature can be approached, how one feature is in relation to another feature on the ground, how the elevation changes can be understood of visualized by a human. There is a need for better technology and tools that show details of a city or national park from several different angles, perspectives, approaches, orientations etc. The present invention addresses these needs, among others described.

Many applications and services for soil mismanagement, remote land acquisition, land use planning, outdoors beautification plans, plants related programs, detailed topographical data, geographically undefined community spaces, etc. need extremely detailed videos, field level data, images, measurements etc. that are not possible or adequately provided by current map solutions such as google maps, apple maps, etc. or by other solutions that are now available for the common business or person on the street. All one can do currently is to hire a specialized team of experts and have them do a custom map creating project on a turnkey basis at considerable cost. There are no tools or services that can meet these varied set of requirements and are also accessible to the common man, to the common user, at little or no cost, especially across a wide area, even at random places across the globe.

### BRIEF SUMMARY OF THE INVENTION

1 The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a system for multiview display that, based on GIS or other such technology, displays a map on a user device to which it is communicatively coupled, such as a laptop, a mobile phone, a tablet or a computer, wherein the map also displays a section or an area with selectable grid points.

FIG. 2 is a perspective block diagram of a map displaying system that comprises an interactive map generator & displayer that provides an interactive map display screen comprising a plurality of regularly distributed grid points, wherein each of the plurality of regularly distributed grid points, when selected or activated, provide a plurality of videos, for display, wherein the plurality of videos correspond to a plurality of perspectives, elevation levels and paths around the selected or activated one of the plurality of regularly distributed grid points.

FIG. 3 is a perspective block diagram of a map displaying system that comprises a grid points generating module to provide displayed grid points for a section of interest of a currently displayed map, wherein the displayed grid points each comprise associated plurality of videos, field data and sourcing data.

FIG. 4 is a perspective view of a display screen on a mobile device (a computer screen, a mobile device screen, a tablet screen, etc.) presented by the map displaying system wherein an interactive middle layer comprising the displayed grid points serves as a middle tier(s) between a satellite image layer (with a map with satellite view) and a conventional map layer displaying streets or terrain.

FIG. 5 is a perspective plan diagram of an interactive grid based map displayed on a user device screen by a map displaying system built in accordance with the present invention, wherein multiple layers of videos are accessible categorized by various usages or services.

FIG. 6 is an exemplary set of drone data paths used for data collection at, or in proximity, to each of the grid points on a map displayed in accordance with the present invention, wherein the data collected for each of the grid points are presented to a user when the user selects or activates a corresponding grid point during a map review activity.

### DETAILED DESCRIPTION OF THE DRAWINGS

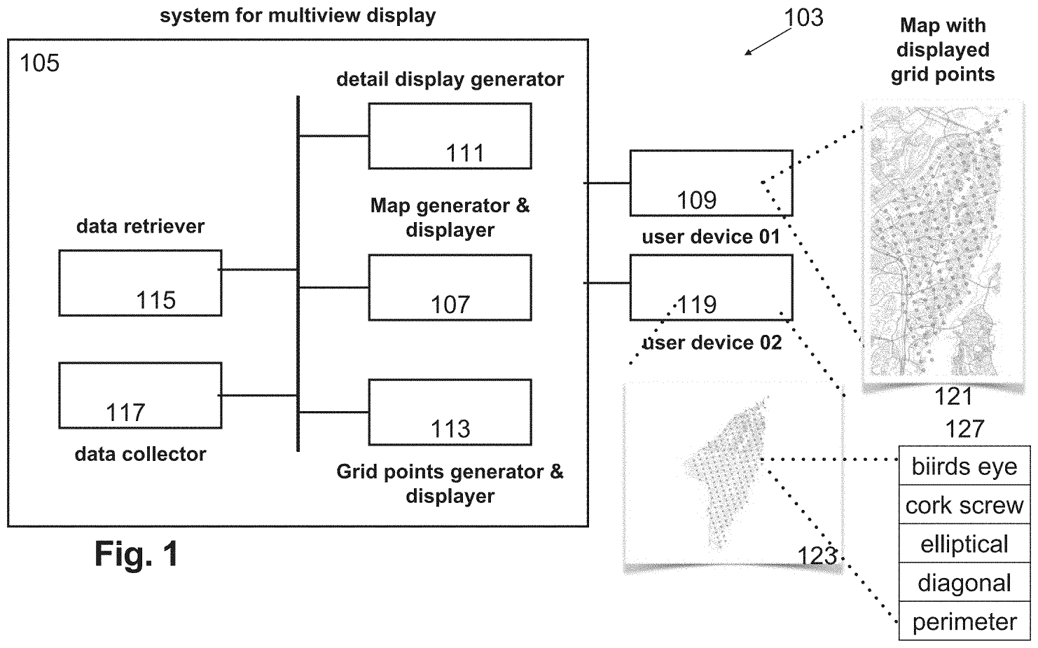

FIG. 1 is a perspective block diagram 103 of a system for multiview display 105 that, based on GIS or other such technology, displays a map on an interactive display unit (user device 109, 119) to which it is communicatively coupled, such as a laptop, a mobile phone, a tablet or a computer, wherein the map also displays a section or an area with selectable grid points. The interactive display unit (109, 119) displays interactive maps which a user can manipulate, interact with, print, share, save etc. Specifically, the system 105 displays an interactive map (on the interactive display unit) comprising a plurality of regularly distributed grid points indicating availability of multiview display data at those grid points. The system 105 comprises a map generator & displayer 107 that facilitates the display of interactive maps 121 with or without grid points, or with grid points partially displayed on sections of a currently displayed map. The system 105 comprises a data retriever 115 that retrieves a plurality of views of data for a currently selected grid point among the regularly distributed grid points on a currently displayed map. The system 105 also comprises a detail display generator 111 that presents a detail display window disposed on a currently displayed map that displays the plurality of views of data.

In one configuration, each of plurality of views of data is a video data associated with a corresponding data collection path defined in relation to the currently selected grid point. Data collection paths are predefined (incorporating a plurality of elliptical, circular, radial, diagonal, circular, ascending elevation cork screw path etc.) or provided in an adhoc mode for particular grid points on a map. In some applications, all data collection at all grid points provide the same similar set of images, views, videos etc. based on a standard set of data collection paths implemented/enforced for data collection from each grid point on a grid in a section or area of a map. The system for multiview display 105 also provides a historical mode, by using which the current set of videos available for a given grid point on the map can be compared to previous set of videos (older data cataloged and made available in date/time order) to determine changes, review progress, highlight mistakes and danger, etc. For example, progress made on a land development project over a 6 month period is reviewed. Similarly, traffic pattern changes between an early morning traffic (viewing corresponding videos) and late evening traffic is reviewed for a grid point by a user. Such historical reviews/comparisons are supported by the present invention.

In the system for multiview display 105 in one configuration, the corresponding data collection path based upon which videos, images, other meteorological and/or geographical data for the grid points is collected and subsequently provided for display comprises one or more of an elliptical path, an expanding cork-screw shaped path, a diagonal path, a circular path, an multi-elevation geometrical shaped path, a perimeter path, a grid perimeter path with changing elevation, and a combination path (i.e. a combination of some of these paths). Other types of paths for video data, audio data, images etc. are also contemplated.

The system for multiview display 105 evaluates suitability of the terrain and location for specific types of projects based on the images and videos (and other types of data) available for a given gird point (identified by a user) on the interactive maps 121 displayed. Such images and videos, for example, collected by a drone/UAV operating in proximity to the grid point and storing them (dynamically if they are communicatively coupled with the system for multiview display 105 or subsequently otherwise) at the system for multiview display 105. It provides tools and capability to facilitate estimation and prediction of specific types of project completion, It also provides tools to promote interpretation of drone data collected (with the help of UAVs) in proximity with (or at) specific grid points. It provides modules and tools tools that aid comprehension of drone data collected that are available for the specific grid points selected by a user on the displayed map(s). These modules and tools tools help a user gain better insight into a project (such as a construction project, an ecological protection project, etc.) and help with decision-making.

The detail display window disposed on a currently displayed map 123 displays the plurality of views 127 of data in a specific default order when not being prompted by a user to display selected ones of the plurality of views of data. For example, for each grid point presented on a currently displayed map 123, when selected (or activated) by a user a data collected along a circular path around that grid point, data collected along a perimeter, data collected along an elliptical path, data collected along a diagonal path, data collected in a cork screw path with increasing elevation are presented in that order, or listed in that order, by default. Note, this data collected can vary based on corresponding services, corresponding usage planned by user, criteria provided by a user, etc. The data collector 117 facilitates such data collection from UAV's/drones, and from other sources too, such as ground based radar, lidar sensors on vehicles and UAVs, sensors in the field, mobile data from mobile devices, etc.. The collected data, for example, is different for different needs. It is topological, geographical, meteorological, various measurements for air quality, etc. based on different services offered to and based on and different needs expressed by users.

In one embodiment of the system 105, the interactive map provided to user devices 109, 119 displays regularly distributed grid points, as shown in the exemplary screen 123 for the user device 119, each of which when selected display further detailed videos and data provided from a plurality of different perspectives, provided with a plurality of paths, and a plurality of spatial orientation. The plurality of different perspectives comprise a first person perspective, a remote viewer perspective and a birds eye view perspective etc. Other perspectives are also contemplated.

In one configuration of the system 105, the plurality of paths for which data collected are available and ready for viewing comprise one or more elliptical paths around or in proximity to grid points, one or more expanding cork-screw shaped paths, one or more diagonal paths, one or more circular paths, one or more grid perimeter paths and one or more combination paths.

In one configuration of the system 105, the plurality of spatial orientation employing which video data, audio data, geographical data, meteorological data, etc. are collected (for each of the grid points) comprise an inward looking orientation, an outward looking orientation, a radial center facing orientation, a constantly center facing orientation, an upward facing orientation and a sweeping orientation.

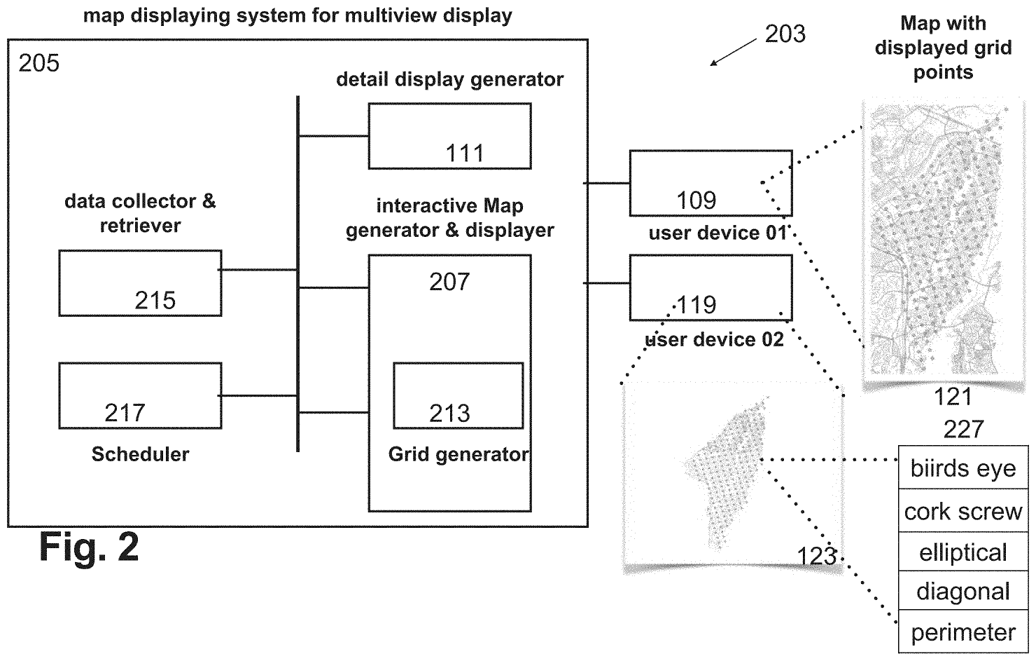

FIG. 2 is a perspective block diagram 203 of a map displaying system 205 that comprises an interactive map generator & displayer 207 that provides an interactive map display screen 123 (on an interactive map display unit, such as the user device comprising a plurality of regularly distributed grid points, wherein each of the plurality of regularly distributed grid points, when selected or activated, provide a plurality of videos, for display, wherein the plurality of videos 227 correspond to a plurality of perspectives, elevation levels and paths around the selected or activated one of the plurality of regularly distributed grid points.

In one configuration, the map displaying system 205 comprises a communication means to communicate a map with interactive grid points to an interactive map display unit (such as a laptop, a mobile device, a computer, a tablet, etc.), communicatively coupled to the map displaying system 205, that presents an interactive map display screen comprising the map with interactive grid points. The map with interactive grid points comprises a plurality of regularly distributed grid points, wherein each of the plurality of regularly distributed grid points, when selected or activated, provide a plurality of videos, etc.

It should be clear that the plurality of videos 227 comprise previously recorded videos that are accessible, that may have previously uploaded by the user or by other users or systems. These include videos collected by one or more drones/UAVs for each of the grid points currently displayed for the map. In one configuration, the videos provide also comprise currently provided live video feeds from one or more cameras in the field (in proximity to a selected grid point) and one or more cameras on moving drones/UAVs currently in the sky in the active mode of video recording and data collection.

The map displaying system 205 further comprises a grid generator 213 that dynamically generates the regularly distributed grid points for a given region of a map currently displayed by the map displaying system 205, and displays the regularly distributed grid points along with the given region of a map currently displayed (as shown in the screen 121 for the user device 109, for example). In a related configuration, a map 121 is displayed partially covered in one or more sections of the map with regularly distributed grid points, wherein any grid point (in the displayed regularly distributed grid points), when selected or activated, causes the map to further provide a plurality of videos from various paths and elevations in proximity to the corresponding one (currently selected or activated) of the grid point for display.

In another related configuration the plurality of videos 227 are those that are sent dynamically from an unmanned aerial vehicle (UAV) with which the map displaying system 205 is communicatively coupled with at the time. Such a UAV would be collecting and communicating data (videos, images measurements etc.) along one or more predefined paths, employing predefined elevations, perspectives, and orientations. In another configuration, the plurality of videos also comprise those sent dynamically by an unmanned aerial vehicle (UAV). In this case, previously collected data (such as videos, images, measurements etc.) are also available for review, analysis or processing, being made available by the data collector & retriever 215, which interacts with the UAVs to receive, store as appropriate, cache as necessary and retrieve videos, images, meteorological data, measurements, etc. In addition, a scheduler 217 makes it possible to do data collection based on a defined schedule from assigned UAVs (fro example) from assigned grid points. The scheduler 217 also facilitates recurring data collection activities from a set of grid points.

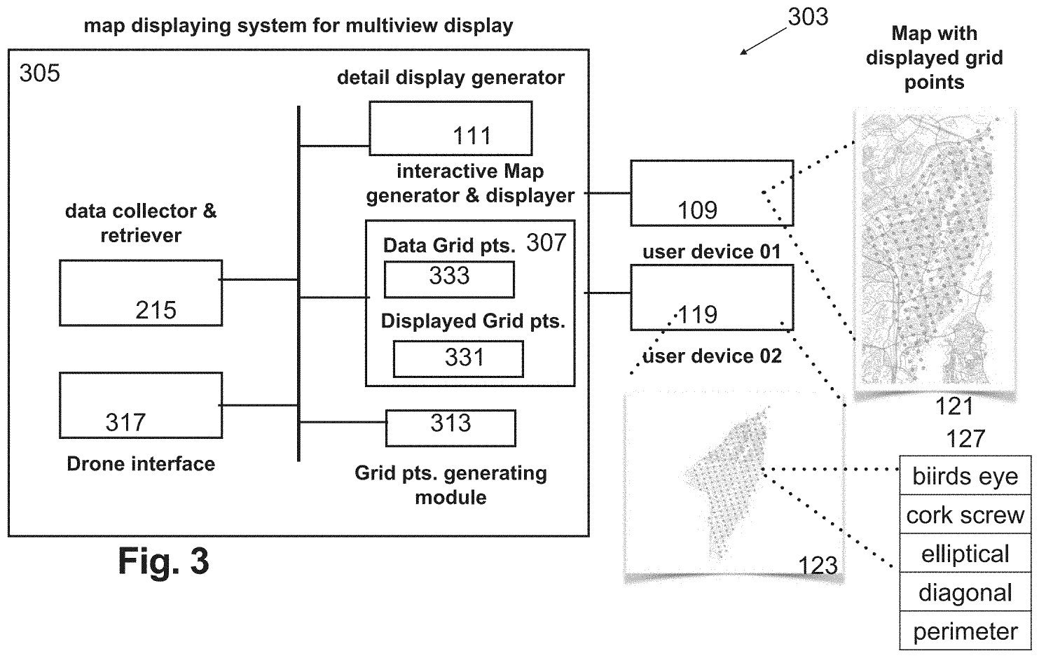

FIG. 3 is a perspective block diagram 303 of a map displaying system 305 that comprises a grid points generating module 313 to provide displayed grid points for a section of interest of a currently displayed map (on an interactive display unit communicatively coupled to the map displaying system 305), wherein the displayed grid points 331 each comprise associated plurality of videos, field data and sourcing data. It also comprises a drone interface 317 to receive videos and and data associated with (or collected for) a plurality of data grid points for the geographical region associated with the displayed map 121, 123, the plurality of data grid points mappable to sections of a currently displayed map. The map displaying system 305 also comprises an interactive map generator & displayer 307 that manages the displayed grid points 331 as well as the data grid points 333, and displays an interactive map using which a user or a system can cause the selection of a data grid point in order to access or view the data (video data, images, meteorological data, topological data etc.) collected and available for that data grid point (or data for a region in proximity to that data grid point). The map displaying system 305 also incorporates at least one of the plurality of data grid points 333 into the displayed grid points 331. It should be noted that not all data grid points 333 for a region of a currently displayed map may be (or need to be) displayed or made accessible. For example, only a subset of available data grid points 331 may be shown as the displayed grid points 333. Such a subset may be selected or identified dynamically using some display criteria in related configurations, or based on a service being used, or based on configuration.

The map displaying system 305 retrieves and displays, based on configuration or based on user preferences (interactively specified by a user, for example) on an interactive display unit communicatively coupled to the map displaying system, one or more videos, field data and sourcing data when one of the displayed grid points are selected or otherwise activated. For example, the interactive display unit may be laptops, tablets, computers, mobile phones or user devices 109, 119.

Sourcing data in one configuration is data provided by other applications, from other services (or systems), remote data from other websites, that are deemed to be relevant to the user, or that are expected to be useful to a current user. Such sourcing data is also historical data in some situations, or use cases. For example, it is historical data made available for a specific grid point that had been collected during a previous year, during a previous data collection activity, or data paid for by the user using a subscription to a service (such as a logistics data from a delivery service).

In one related configuration, the map displaying system 305 retrieves and displays one or more videos, field data and sourcing data when one of the displayed grid points are selected or otherwise activated.

In another related configuration of the map displaying system 305, the plurality of videos associated with each of the displayed grid points comprise videos collected from one or more perspectives along one or more paths, wherein the one or more paths comprise an elliptical path, an expanding cork-screw shaped path spanning multiple elevation levels, a diagonal path, a circular path, a grid perimeter path and a combination path (that combines one or more of the other paths).

In one configuration, all the data grid points 333 are incorporated into the displayed grid points 331 that show up on a map 121. In another related configuration, some of the displayed grid points do not have any of the data grid points associated with it, and the map displaying system 305 then, using a selection criteria, selectively retrieves data (videos, images, field data, etc.) from other grid points in proximity to a selected displayed grid point without data and displays the retrieved data. Thus the map displaying system 305 dynamically assembles data (videos, images, field data, etc.) for a selected displayed grid point, as necessary, in some configurations.

In another related configuration, the displayed grid points 331 for a section of interest of a displayed map 121 comprise an interactive selectable layer of videos and field data (wherein field data is, for example, crop related data, air quality related data, water quality related data, soil related data, topology related data, meteorological data, construction related data, building repair related data, etc.)

In yet another related configuration of the map displaying system 305 the interactive selectable layer of videos and field data forms an interactive middle tier between a satellite image view of a map and a ground-level view of the map. For example, the map 121 displays not only satellite view when invoked, but also street level data or a topological ground level view when invoked, while it specifically displays the data grid pints view for detailed videos, images, field data etc. for each of the displayed grid points such that the user has the ability to inspect or see in minute details the terrain, the views from several perspectives (first person, remote viewer, bird eye etc.), videos from several different orientations (inward looking, outward looking, inward with rising elevation, outward with rising elevation etc.), the views from several elevations, the approaches to all locations of the map etc.

In another configuration, the map displaying system 305 displays a satellite image layer displaying the satellite image view of a geographical region. It also displays a ground-level image layer displaying the ground-level image view of a geographical region. It further displays an interactive middle-tier view comprising the displayed grid points 331 for a section of interest of a displayed map 121.

In another related configuration, the map displaying system 305 displays an interactive map combining a ground level image and the displayed grid points 331 for a section of interest of a displayed map 121. Upon user selection of one of the displayed grid points, the map displaying system then retrieves and displays a corresponding one or more videos, field data and sourcing data.

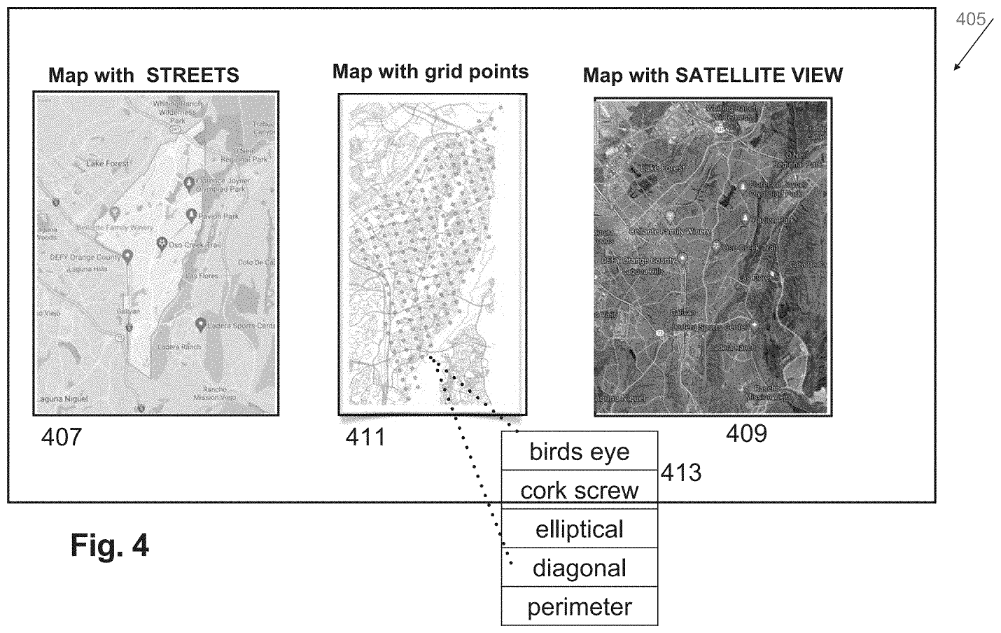

FIG. 4 is a perspective view of a display screen 405 on a mobile device (a computer screen, a mobile device screen, a tablet screen, etc.) presented by the map displaying system 305 wherein an interactive middle layer comprising the displayed grid points 331 serves as a middle tier(s) between a satellite image layer 407 (with a map with satellite view) and a conventional map layer displaying streets or terrain. For example, the map displaying system 305 displays a satellite image layer displaying the satellite image view of a geographical region. It also displays a conventional map layer displaying the ground-level view with streets and trails etc. of the same geographical region. It further displays an interactive middle-layer view comprising the displayed grid points 331 for the section of interest on the displayed map.

In a related configuration, mobile devices and computers communicatively coupled to the map displaying system 305 are presented with a multi-layer map by the the map displaying system 305, wherein an interactive middle layer comprising a plurality of videos from different perspectives and orientations, and images, for each of the the displayed grid points 331 serves as a middle layer between a satellite image layer 407 (with a map with satellite view) and a conventional map layer displaying streets or terrain.

In a different configuration, the conventional map layer as one of the layers adjacent to the grid points based middle layer is replaced by a ground-level image layer that displays ground-level image(s) of the geographical region currently on display on the map.

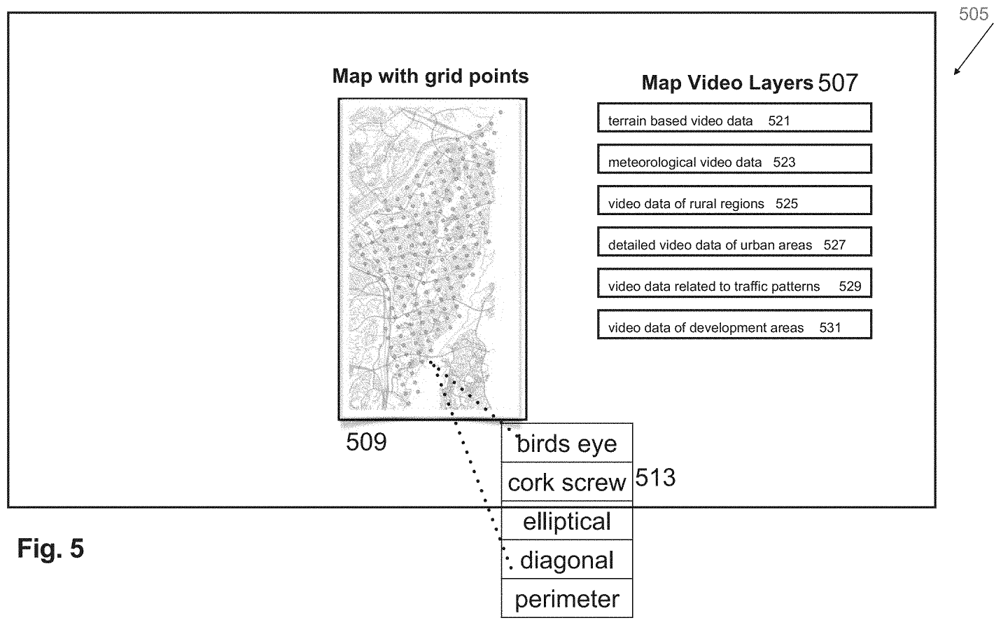

FIG. 5 is a perspective plan diagram of an interactive grid based map 509 displayed on a user device screen 505 by a map displaying system built in accordance with the present invention, wherein multiple layers of videos 507 are accessible categorized by various usages or services. In one configuration, the map displaying system 305 presents the grid based map 509 where when one of the grid points on the map is selected, the plurality of map video layers 507 (video based layers of data) are presented, wherein each of the plurality of map video layers 507 (video based layers) presents one of a terrain based video data, meteorological video data, video data of rural regions, detailed video data of urban areas, video data related to traffic patterns, wherein each of the a plurality of video based layers presents their corresponding video data employing multiple perspectives, multiple orientations, multiple elevations and multiple paths. For example, the multiple perspectives comprise first person perspective, remote viewer perspective, birds eye view perspective etc., the multiple orientations comprise inward looking orientation, outward looking orientation, radial orientation, diagonal orientation, etc., the multiple elevations comprise ground hugging, increasing elevations, decreasing elevations, highest elevation (say at 400 feet), ascending and descending elevations, etc., and multiple paths comprise circular, perimeter, radial, square, rectangular with varying corner elevations, diagonal elliptical, cork screw with gradual changing elevations, etc.

In a related configuration, the grid points on the map 509 are hidden, in that they are not displayed by default, even as the grid points are implemented, and the hidden grid points are effective for retrieving and displaying multiple layers of videos, such as when a user clicks or touches at a point on a displayed map. Each of the multiple layers of videos may be individually presented on an appropriate window/screen based on configuration, or a few on the multiple layers of videos may be combined into a common set based on configuration too.

In another related embodiment, the interactive grid based map 509 displayed on a user device screen 505 by a map displaying system 305 built in accordance with the present invention, wherein multiple layers of videos 507 are each separately displayed when selected, in an appropriate window, each of the windows presenting video data, audio data, images, 3D models etc. for the same grid point currently selected by the user on a map (the map may or may not show grid points, i.e. the grid points may be hidden on the map).

In a related embodiment, the map displaying system 305 facilitates creation and display of orthomosaic maps around a region comprising one or more grid points. For example, it helps create an orthomosaic maps to virtually tour working sites at a construction site or real estate offerings, wherein the drone data available for a grid point (one or more images, one or more videos, for example) is processed to generate a mosaic view for presenting to a user (and for saving too). Such orthomosaic maps for a set of grid points on a map provide the ability to generate site progress reports over time. They also, for example, help deliver up-to-date maps of agricultural land, and conduct inspections over difficult or dangerous terrain.

In another embodiment, the map displaying system 305 also facilitates photogrammetry employing drone data available for a set of grid points on a map 121. It facilitates extracting the geometric information of a two-dimensional image or from one or more videos. By combining a lot of images (photos) and portions of videos, it is able to create a three-dimensional image for the set of grid points. In a related embodiment, such post processing of images/video data collected for the set of grid points of the map 121 is conducted using powerful tools, to generate 3D models useful for construction, agriculture, urban planning etc.

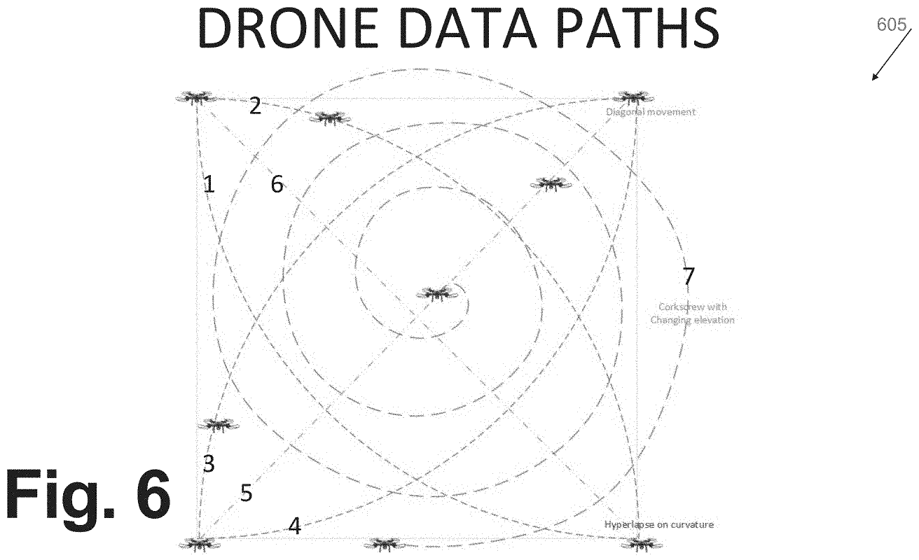

FIG. 6 is an exemplary set of drone data paths used for data collection at or in proximity to each of the grid points on a map displayed in accordance with the present invention, wherein the data collected for each of the grid points are presented to a user when the user selects or activates a corresponding grid point during a map review activity. The drone data paths in one configuration are a standard set of paths for which data is collected and subsequently made available on a map comprising grid points presented to a user on a mobile device, computer or tablet. Data paths 605 comprise elliptical paths (1,2), (3,4), diagonal paths 5, 6 through the grid point at the center, a cork-screw path 7 with increasing elevation, etc. Other data paths are also contemplated for drone data collection and viewing of such collected data. Note that for each of these paths, drone data are collected in multiple orientations, with multiple perspectives. Such drone data collected are presented to the user for review/viewing when the user selects or activates one of the grid points (it's corresponding drone data are then made available for review by a user in appropriate windows).

In a related embodiment, the map displaying system 305 also facilitates drone data collection. For example, for each grid point on a map with grid points, it facilitates drone data collection (dynamically communicated by drones in the field, or accessed from servers that store such data) of the following types:
Images: Multi-corner inward facing image/shot towards center.
Images: Multi-corner outward facing image/shot diagonally away from center
Video: Outward cork-screw spiral from center with increasing elevation gain accompanied by center facing video data collection
Video or Images: Hyperlapse mode video and shots from east to west and north to south
Video or Images: Hyperlapse with corner to corner diagonal sweep and waypoints at middle of radial.
Night time videos and photos of above
Time-lapse photos: Optional time-lapse photo based on GPS coordinates for specific locations
Bird's-eye-view photo from center.
Temperature, moisture content, pollution, wind speed measurements on special cases.
Drone Temperature & Relative Humidity Monitoring

These exemplary set of drone data are then provided to a user on his interactive device (such as mobile device, computer or tablet via the map with displayed grid points 121, such as when the user selects any of the displayed grid points.

In another embodiment, the mapping system 305 also supports drone operations management involving the following exemplary activities:
Region of Interest (RInt) selection and specification
Grid data points generation
Drone data collection route planning
Drone data collection scheduling
Data collection operational management
Data collection completion notification
Collected data upload and review
Error data review

In addition, in another embodiment, the mapping system 305 further comprises a server-side infrastructure to facilitate drone data collection, storage and retrieval of drone data collected, and their dissemination. Thus the server-side infrastructure facilitates storage, controlled access and retrieval of drone data, and it comprises:
A drone data Upload means
A drone data Storage and easy Search means
A drone data Update means
A drone data Download means-download as a portfolio
A frequent drone data “update forwarding” means
A drone data “change flagging” means
A publicly accessible online search and retrieval means
Subscription model for drone data access of specific regions/sectors

In one configuration, the grid point generation module 313 facilitates generation of a map with grid points. It implements a process that starts with a map (such as a USGS map of a city) and facilitates identification of one or more regions on the map, and grid point generation for those one or more regions, employing a grid point distance value (which is a distance between adjacent grid points). The grid point distance value can be changed by a user and various values can be specified to generate a corresponding set of grid points for a section of a map (such as a polygon on a map representing a neighborhood).

For example, a user might want to download a map with GIS data from USGS website (such as: https://www.sciencebase.gov/catalog/item/59f164e3e4b0220bbd9c6e90). After downloading the GIS map from USGS website, the user can use the tool QGIS to create grid points, or instruct the grid point generation module 313 to identify one or two specific sections on the map, such as neighborhoods (or even towns), highlight them (such as by drawing a polygon around it etc.). It can, as necessary, create a new map with only the identified one or two specific sections on the map. Then cause the creation of grid points in those specific sections employing a default grid point distance (or user specified values for the grid point distance). It can the save those map sections with grid points into shape files (or other formats) for subsequent viewing or processing. Grid point maps can be created using the necessary vertical and horizontal spacing for the grid points.

In some configurations, a grid point layer is generated, interactively by a user with the help of the grid point generation module 313, for a section of a map identified by a polygon (selected by a user or by set parameters) which is then intersected with the topological or city map showing the section (map with polygon for example) to generate a corresponding section with grid points that can be saved (for data collection at those grid points by a drone/UAV for example) or processed further. For example, a grid layer with just grid points is otherwise accessed or created, then the grid point generation module 313 performs an intersection (for example when instructed by a user or when programmatically triggered) with a polygon shape on a given map (of a city or neighborhood, etc.) to generate the grid points for the region inside the polygon, thereby generating a map with grid points for the region of the map inside the polygon. More specifically, this is typically an intersection operation of maps, and the the intersection layer thus generated is saved as a shapefile with those grid points. The grid points on that intersection layer is also extracted into an excel file or as a list based on preferences, and the list of grid points are subsequently used to schedule data collection at those grid points using drones/UAVs for various use-cases or services.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

As one of ordinary skill in the art will appreciate, the terms “maps” and “GIS maps,” as may be used herein, include presentations that connect data to a map, integrating location data (where things are) with all types of descriptive information (what things are like there). The term “maps” used herein incorporates geographic containers for the data layers and analytics you want to work with, incorporating imagery, features, and basemaps linked to spreadsheets and tables.

The terms “drone data” and “data collected” used herein, as one of ordinary skill in the art will appreciate, includes images, audio information, video information, measurements, tables, lists, meteorological data, topological data and field collected data.

The terms “multiview video displays” used herein includes videos that show video data in various views (top view, bottom-up view, side views, inward facing views, outward facing views, changing elevation views, birds-eye view etc.) In addition, this term encompasses videos and data provided from a plurality of different perspectives, provided with a plurality of paths, and a plurality of spatial orientation. The plurality of different perspectives comprise a first person perspective, a remote viewer perspective and a birds eye view perspective etc. Other perspectives are also contemplated.

The term “drone” used herein includes airborne vehicles that fly in the air, UAVs, and other such devices both big and small.

As one of ordinary skill in the art will appreciate, the terms “path” as may be used herein, include various flying patterns employed by a drone, such as a circular flying pattern around a base point, an elliptical pattern, cork-screw pattern etc.

Although the present invention has been described in terms mobile devices and servers, it must be clear that the present invention also applies to other types of devices including mobile devices, laptops with a browser, a hand held device such as a PDA, a television, a set-top-box, a media center at home, robots, robotic devices, vehicles capable of navigation, and a computer communicatively coupled to the network.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

I claim:

1. A system for multiview display comprising:
an interactive map on an interactive display unit, comprising a plurality of regularly distributed grid points indicating availability of multiview display data at those grid points;
a data retriever unit, communicatively coupled to the interactive display unit, that retrieves a plurality of views of data for a currently selected grid point among the regularly distributed grid points on a currently displayed map; and
a detail display window disposed on a currently displayed map on the interactive display unit, that displays the plurality of views of data.

2. The system for multiview display of claim 1 wherein each of plurality of views of data is a video data associated with a corresponding data collection path defined in relation to the currently selected grid point.

3. The system for multiview display of claim 2 wherein the corresponding data collection path is one of an elliptical path, an expanding cork-screw shaped path, a diagonal path, a circular path, a grid perimeter path and a combination path.

4. The system for multiview display of claim 1 wherein the detail display window disposed on a currently displayed map displays the plurality of views of data in a specific default order when not being prompted by a user to display selected ones of the plurality of views of data.

6. The system of claim 1 further comprising:
the interactive map displaying regularly distributed grid points, each of which when selected display further detailed videos and data provided from a plurality of different perspectives, provided with a plurality of paths, and a plurality of spatial orientation.

7. The system of claim 6 wherein the plurality of different perspectives comprise a first person perspective, a remote viewer perspective and a birds eye view perspective.

8. The system of claim 6 wherein the plurality of paths comprise one or more elliptical paths, one or more expanding cork-screw shaped paths, one or more diagonal paths, one or more circular paths, one or more grid perimeter paths and one or more combination paths.

9. The system of claim 6 wherein the plurality of spatial orientation comprise an inward looking orientation, an outward looking orientation, a radial center facing orientation, a constantly center facing orientation, an upward facing orientation and a sweeping orientation.

10. A map displaying system comprising:
communication means to communicate a map with interactive grid points to an interactive map display unit, communicatively coupled to the map displaying system, that presents an interactive map display screen comprising the map with interactive grid points;
wherein the map with interactive grid points comprises a plurality of regularly distributed grid points, wherein each of the plurality of regularly distributed grid points, when selected or activated, provide a plurality of videos, for display, wherein the plurality of videos correspond to a plurality of perspectives, elevation levels and paths around the selected or activated one of the plurality of regularly distributed grid points.

11. The map displaying system of claim 10 further comprising:
a grid generator that dynamically generates the regularly distributed grid points for a given region of a map currently displayed by the map displaying system, and displays the regularly distributed grid points along with the given region of a map currently displayed.

12. The map displaying system of claim 10 that displays a map on the interactive map display unit that is partially covered in one or more sections of the map with regularly distributed grid points, wherein any grid point in the displayed regularly distributed grid points, when selected or activated, provide a plurality of videos from various paths and elevations in proximity to the corresponding one of the grid point for display.

13. The map displaying system of claim 10 wherein the plurality of videos presented to the interactive map display unit are those sent dynamically from an unmanned aerial vehicle (UAV).

14. The map displaying system of claim 10 wherein the plurality of videos also comprise those sent dynamically by an unmanned aerial vehicle (UAV).

15. A map displaying system comprising:
a grid points generating module to provide a displayed grid points for a section of interest of a displayed map, wherein the displayed grid points each comprise associated plurality of videos, field data and sourcing data;
a drone interface to receive videos and and data associated with a plurality of data grid points for the geographical region associated with the displayed map, the plurality of data grid points mappable to sections of the displayed map;
the map displaying system incorporating at least one of the plurality of data grid points into the displayed grid points; and
the map displaying system retrieving and displaying, on an interactive display unit communicatively coupled to the map displaying system, one or more videos, field data and sourcing data when one of the displayed grid points are selected or otherwise activated.

16. The map displaying system of claim 15 wherein plurality of videos associated with each of the displayed grid points comprise videos collected from one or more perspectives along one or more paths, wherein the one or more paths comprise an elliptical path, an expanding cork-screw shaped path spanning multiple elevation levels, a diagonal path, a circular path, a grid perimeter path and a combination path.

17. The map displaying system of claim 15 wherein the displayed grid points for a section of interest of a displayed map, currently displayed on the interactive display unit, comprise an interactive selectable layer of videos and field data.

18. The map displaying system of claim 17 wherein the interactive selectable layer of videos and field data forms an interactive middle tier between a satellite image view of a map and a ground-level view of the map.

19. The map displaying system of claim 15 further displaying on the the interactive display unit:
a satellite image layer displaying the satellite image view of a geographical region;
a ground-level image layer displaying the ground-level image view of a geographical region; and
and an interactive middle-tier view comprising the displayed grid points for a section of interest of a displayed map.

20. The map displaying system of claim 15 displaying on the the interactive display unit:
an interactive map combining a ground level image and the displayed grid points for a section of interest of a displayed map; and
upon user selection of one of the displayed grid points, the map displaying system retrieving and displaying a corresponding one or more videos, field data and sourcing data.
